(19) United States
(12) Patent Application Publication
(10) Pub. No.: US 2019/0188715 A1
(43) Pub. Date: Jun. 20, 2019

(54) SYSTEM AND COMPUTER-IMPLEMENTED METHOD FOR REQUIRING AND VALIDATING OPERATOR IDENTIFICATIONS IN CARD-NOT-PRESENT TRANSACTIONS

(71) Applicant: Mastercard International Incorporated, Purchase, NY (US)

(72) Inventors: Mark B. Hey, St. Peters, MO (US); Bheemeswara Ankathi, Chatham, IL (US)

(73) Assignee: Mastercard International Incorporated, Purchase, NY (US)

(21) Appl. No.: 15/842,629

(22) Filed: Dec. 14, 2017

(51) Int. Cl. G06Q 20/40; G06Q 20/34

(52) U.S. Cl. CPC G06Q 20/4014; G06Q 20/4016; G06Q 20/34

(57) ABSTRACT

A system and computer-implemented method for processing CNP transactions using a 3DS protocol, and protecting against fraud by requiring and validating merchant (or acquirer) and card issuer operator IDs prior to authorization. Operator IDs may be obtained by completing a compliance test and enrolling in a compliance program. When an AREQ is received from a merchant (or acquirer), the presence and validity of the merchant's unique operator ID is checked. The AREQ may be sent to a corresponding card issuer depending on, e.g., whether the merchant's unique Operator ID is confirmed. When an ARES is received from the card issuer, the presence and validity of the card issuer's unique operator ID is checked. The ARES may be sent to the merchant depending on, e.g., whether the card issuer's unique Operator ID is confirmed.

### FIELD

The present invention relates to systems and methods for processing card-based transactions and protecting against fraud, and more particularly, embodiments provide a system and computer-implemented method for processing card-not-present transactions and protecting against fraud by requiring and validating merchant and card issuer operator identifications prior to authorizing the transactions.

### BACKGROUND

Card-based transactions may involve several parties, including cardholders, merchants, card issuers, and interchange networks. In some cases, the merchant may deal directly with the card issuer via the interchange network, while in other cases, an acquirer, which may be a bank, credit union, or other financial institution or other business, may act as an intermediary for the merchant. The card issuer may be a financial institution or other business which issues the card to the cardholder. The interchange network may be substantially any network, such as the network provided by Mastercard, Inc., which facilitates the transaction between the merchant/acquirer and the card issuer.

EMVCo, LLC, is a consortium of Mastercard, Inc., and several other interchange networks. EMVCo, LLC, created the EMV® Three-Domain Secure (3DS) XML-based messaging protocol to enable cardholders to authenticate themselves with card issuers when making card-not-present (CNP) purchases. The additional layer of security helps to prevent unauthorized CNP transactions and protects merchants/acquirers and card issuers from fraud. The three domains include an acquirer domain (i.e., the merchants and the banks to which payment is being made), an issuer domain (i.e., the banks that issue the cards being used), and an interchange domain (i.e., the infrastructure of the payment system). The 3DS protocol is used by the Mastercard Identity Check® product and similar authentication products.

However, interchange networks may have some difficulty identifying the true senders of 3DS messages due to the current reseller model of 3DS software. Typically, resellers send their software through testing and approval, and then sell that software directly to merchants/acquirers and card issuers. There is no trace identification (ID) in a 3DS 1.0 message that indicates the message originated from the buyer of the software, which often causes confusion with regard to who is the overall compliant party to the transaction. This may cause authentication and/or security concerns. For example, in the absence of strict compliance enforcement, some non-compliant merchants may enjoy the benefits afforded to compliant merchants, such as liability transfer, while avoiding their obligations, such as paying interchange fees. For some interchange networks, approximately one-half of all authentication transactions are via this reseller model.

EMVCo LLC has attempted to address the trace ID issue in the 3DS 2.0 specification by introducing the Operator ID data elements, but there is still a need to validate these values in order to improve the CNP transaction process.

This background discussion is intended to provide information related to the present invention which is not necessarily prior art.

### SUMMARY

Embodiments of the present invention address the above-described and other problems by providing a system and computer-implemented method for processing CNP transactions and protecting against fraud by requiring and validating merchant and card issuer operator IDs prior to authorizing the transactions.

In a first embodiment of the present invention, a system is provided for managing an authentication process initiated by an authentication request from a merchant/acquirer to a card issuer for a CNP payment transaction. The system may comprise electronic communications, memory, and processing elements. The communications element may facilitate communications via a communications network. The memory element may store a plurality of valid operator IDs. The processing element may perform the following actions. An authentication request message (AREQ) from the merchant/acquirer may be received via the communications element. Whether the AREQ contains a merchant/acquirer operator ID may be determined, and the authentication process may be terminated and a denial message may be sent to the merchant/acquirer via the communications element rejecting the AREQ if the AREQ does not contain the merchant/acquirer operator ID. Whether the merchant/acquirer operator ID contained in the AREQ is valid may be determined by searching for the merchant/acquirer operator ID among the plurality of valid operator IDs stored in the memory element, and the authentication process may be terminated and a denial message may be sent to the merchant/acquirer via the communications element rejecting the AREQ if the merchant/acquirer operator ID is not valid.

The AREQ may be sent to the card issuer via the communications element, and an authentication response message (ARES) may be received from the card issuer via the communications element. Whether the ARES contains a card issuer operator ID may be determined, and the authentication process may be terminated and a denial message may be sent to the merchant/acquirer via the communications element rejecting the AREQ if the ARES does not contain the card issuer operator ID. Whether the card issuer operator ID contained in the ARES is valid may be determined by searching for the card issuer operator ID among the plurality of valid operator IDs stored in the memory element, and the authentication process may be terminated and a denial message may be sent to the merchant/acquirer via the communications element rejecting the AREQ if the card issuer operator ID is not valid. The ARES from the card issuer may be sent to the merchant/acquirer via the communications element if the merchant/acquirer operator ID and the card issuer operator ID are valid.

In a second embodiment of the present invention a computer-implemented method is provided for improving the functioning of a computer for managing an authentication process initiated by an authentication request from a merchant/acquirer to a card issuer for a CNP payment transaction. The computer-implemented method may comprise the following steps. An AREQ may be received from the merchant/acquirer. Whether the AREQ contains a merchant/acquirer operator ID may be determined, and the authentication process may be terminated and a denial message may be sent to the merchant/acquirer rejecting the AREQ if the AREQ does not contain the merchant/acquirer operator ID. Whether the merchant/acquirer operator ID contained in the AREQ is valid may be determined by searching for the merchant/acquirer operator ID among a plurality of valid operator IDs, and the authentication process may be terminated and a denial message may be sent to the merchant/acquirer rejecting the AREQ if the merchant/acquirer operator ID is not valid.

The AREQ may be sent to the card issuer, and an ARES may be received from the card issuer. Whether the ARES contains a card issuer operator ID may be determined, and the authentication process may be terminated and a denial message may be sent to the merchant/acquirer rejecting the AREQ if the ARES does not contain the card issuer operator ID. Whether the card issuer operator ID contained in the ARES is valid may be determined by searching for the card issuer operator ID among the plurality of valid operator IDs, and the authentication process may be terminated and a denial message may be sent to the merchant/acquirer rejecting the AREQ if the card issuer operator ID is not valid. The ARES from the card issuer may be sent to the merchant/acquirer if the merchant/acquirer operator ID and the card issuer operator ID are valid.

Various implementations of the foregoing embodiments may include any one or more of the following additional features. The CNP transaction may follow a 3DS protocol, the merchant/acquirer may send the AREQ using 3DS server software, and the card issuer may send the ARES using ACS software. The merchant/acquirer operator ID and the card issuer operator ID may each include a unique alphanumeric identifier. A vendor may be allowed to have a vendor operator ID, and the merchant/acquirer may be allowed to use the vendor operator ID as the merchant/acquirer operator ID.

The merchant/acquirer and the card issuer may be required to complete compliance testing, and thereafter the merchant/acquirer and the card issuer may be enrolled in a compliance program. The merchant/acquirer operator ID may be assigned to the merchant/acquirer, and the card issuer operator ID may be assigned to the card issuer. The merchant/acquirer operator ID and the card issuer operator ID may be stored in a compliance database, and determining whether the merchant/acquirer operator ID contained in the AREQ is valid and whether the card issuer operator ID contained in the ARES is valid may include querying the compliance database.

This summary is not intended to identify essential features of the present invention, and is not intended to be used to limit the scope of the claims. These and other aspects of the present invention are described below in greater detail.

### DRAWINGS

Embodiments of the present invention are described in detail below with reference to the attached drawing figures, wherein:

FIG. 1 is a depiction of an embodiment of a system for processing CNP transactions and protecting against fraud;

FIG. 2 is a high-level flowchart of actions performed by the system of FIG. 1; and

FIG. 3 is a flowchart of steps in an embodiment of a computer-implemented method for processing CNP transactions and protecting against fraud.

The figures are not intended to limit the present invention to the specific embodiments they depict. The drawings are not necessarily to scale.

### DETAILED DESCRIPTION

The following detailed description of embodiments of the invention references the accompanying figures. The embodiments are intended to describe aspects of the invention in sufficient detail to enable those with ordinary skill in the art to practice the invention. The embodiments of the invention are illustrated by way of example and not by way of limitation. Other embodiments may be utilized and changes may be made without departing from the scope of the claims. The following description is, therefore, not limiting. It is contemplated that the invention has general application to processing financial transaction data by a third party in industrial, commercial, and residential applications. The scope of the present invention is defined only by the appended claims, along with the full scope of equivalents to which such claims are entitled.

In this description, references to “one embodiment,” “an embodiment,” or “embodiments” mean that the feature or features referred to are included in at least one embodiment of the invention. Separate references to “one embodiment,” “an embodiment,” or “embodiments” in this description do not necessarily refer to the same embodiment and are not mutually exclusive unless so stated. Specifically, a feature, component, action, step, etc. described in one embodiment may also be included in other embodiments, but is not necessarily included. Thus, particular implementations of the present invention can include a variety of combinations and/or integrations of the embodiments described herein.

Broadly characterized, the present invention relates to systems and methods for processing card-based transactions and protecting against fraud. More particularly, embodiments provide a system and computer-implemented method for processing CNP (e.g., telephone-based, fax-based, Internet-based, etc.) transactions and protecting against fraud by requiring and validating merchant and card issuer operator IDs prior to authorizing the transactions. Although described herein for the purpose of illustration in the context of the 3DS protocol, the present invention is not limited thereto, and embodiments may be used with substantially any suitable alternative protocol.

The 3DS 2.0 specification will allow merchants to pass more data via their 3DS Server software to card issuers for frictionless authentication via their ACS software. The advantage of this data is to allow the ACS software to perform risk-based authentication based on the provided data elements without needing to challenge the cardholder. EMVCo, LLC, will be responsible for the testing and approval cycle of these 3DS components to ensure they meet all specification requirements prior to implementation. After testing and approval, EMVCo, LLC, will assign a required Reference ID number to each merchant/acquirer and to each card issuer. The Reference ID data element will be a required field in all 3DS messages, so all interchange networks will be required to support this data element and to validate the Reference ID number in all 3DS messages.

In addition to the Reference ID data element, 3DS 2.0 will include a 3DS Server Operator ID data element and a ACS Operator ID data element. The latter two data elements are categorized as conditional by the specification, which indicates whether and how these data elements will be supported, including assigning the Operator IDs, and will be determined by each interchange network. For example, one interchange network may require these data elements for its customers, such that any transaction that does not contain either Operator ID will return an error to the sender, while another interchange network may not require them.

In embodiments of the present invention, an interchange network may assign the Operator IDs prior to the 3DS component's implementation. After assignment, the interchange network may store the Operator IDs in a compliance database. Upon initialization of an authentication message via a merchant's 3DS Server, the interchange network's directory server may perform a call-out to the compliance database to validate that the merchant's 3DS Server Operator ID was generated by the interchange network and assigned to that 3DS Server component. After the initial validation has been performed on the 3DS Server Operator ID, the directory server may perform the same validation steps for the card issuer's ACS Operator ID. By validating 3DS Server Operator IDs and ACS Operator IDs during authentications, the interchange network may be able to quickly determine whether or not each authentication message originated from an approved user of the 3DS software, run compliance against the user rather than against the vendor, and avoid fraudulent transactions if an invalid Operator ID is used. Thus, embodiments facilitate developing closer relationships with customers who use 3DS software. In the past, the focus has been on the vendors who supplied the software, but there is a business need to acknowledge the users likely to keep this service “in-house” and therefore push card issuers to start catering some of their other fraud/authentication products to these customers.

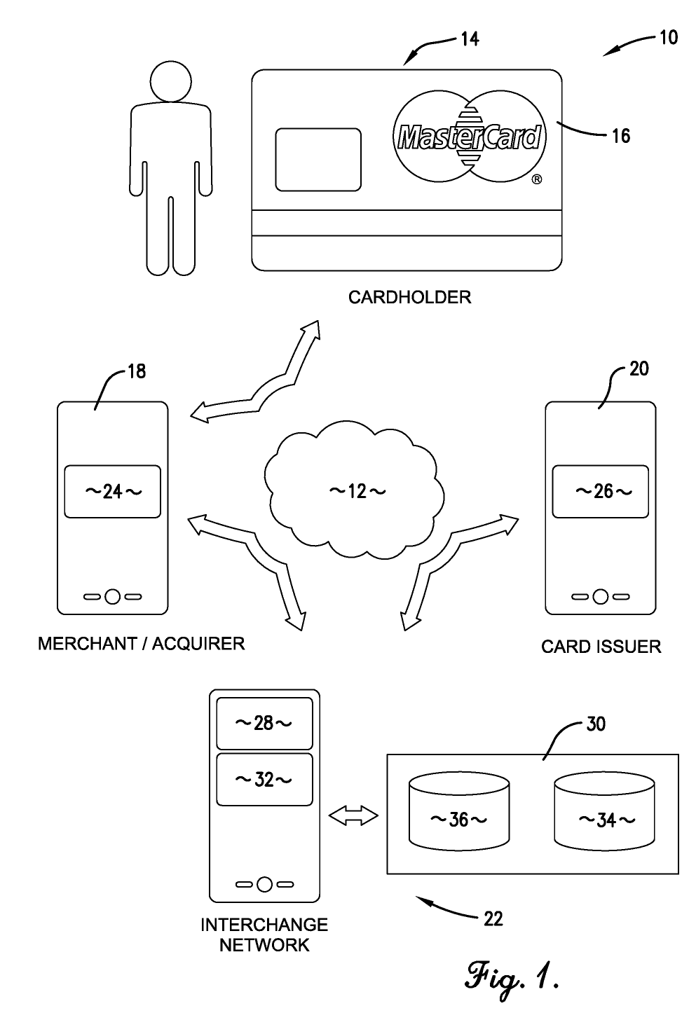

Referring to FIG. 1, an embodiment of a system 10 and its operating environment is shown for processing CNP transactions and protecting against fraud by requiring and validating merchant and card issuer operator IDs prior to authorizing 3DS transactions. The system 10 may and its operating environment may broadly comprise an electronic communications network 12; a cardholder device 14 operated by a Cardholder having a credit, debit, or other payment card 16; a merchant/acquirer device 18 operated by a Merchant or Acquirer; a card issuer device 20 operated by a Card Issuer; and an interchange network system 22 operated by an Interchange Network.

The electronic communications network 12 may be substantially any network suitable for communicating signal traffic between the entities involved in the CNP transaction.

The cardholder device 14 may be substantially any suitable personal computing device, such as a desktop, laptop, or tablet computer or a smartphone, configured to process and communicate relevant transaction information, such as information about the card 16, between the cardholder device 14 and the merchant/acquirer device 18 via the communications network 12. The merchant/acquirer device 18 may be substantially any suitable signal processing and communication device, such as a server, configured to process and communicate relevant transaction information, such as transmitting authentication requests and receiving authentication responses, between the merchant/acquirer device 18 and the interchange network device 22 via the communications network 12. To facilitate this function, the merchant/acquirer device 18 may execute a suitable software product 24, such as 3DS Server software. Similarly, the card issuer device 20 may be substantially any suitable signal processing and communication device, such as a server, configured to process and communicate relevant transaction information, such as receiving authentication requests and transmitting authentication responses, between the card issuer device 20 and the interchange network device 22 via the communications network 12. To facilitate this function, the card issuer device 20 may execute a suitable software product 26, such as ACS software.

The interchange network system 22 may be substantially any suitable signal processing and communication system configured to facilitate CNP transactions between the Cardholder and the Merchant/Acquirer, and to protect against fraud in such transactions. The interchange network system 22 may broadly including an electronic communications element 28, an electronic memory element 30, and an electronic processing element 32. The electronic memory element 30 may be configured to store electronic data, including data relevant to the process of authenticating CNP transactions, such as a Compliance Database 34 containing a plurality of valid operator IDs and a Directory Database 36 associating particular Card Issuers with particular Merchants. The electronic processing element 32 may be configured to execute a suitable software product, such as the Mastercard Identity Check® software product using the 3DS protocol, to perform aspects of the process of authenticating CNP transactions, which may involve accessing data stored on the memory element 30 and/or engaging in communication via the communications element 28 in order to perform aspects of the present invention.

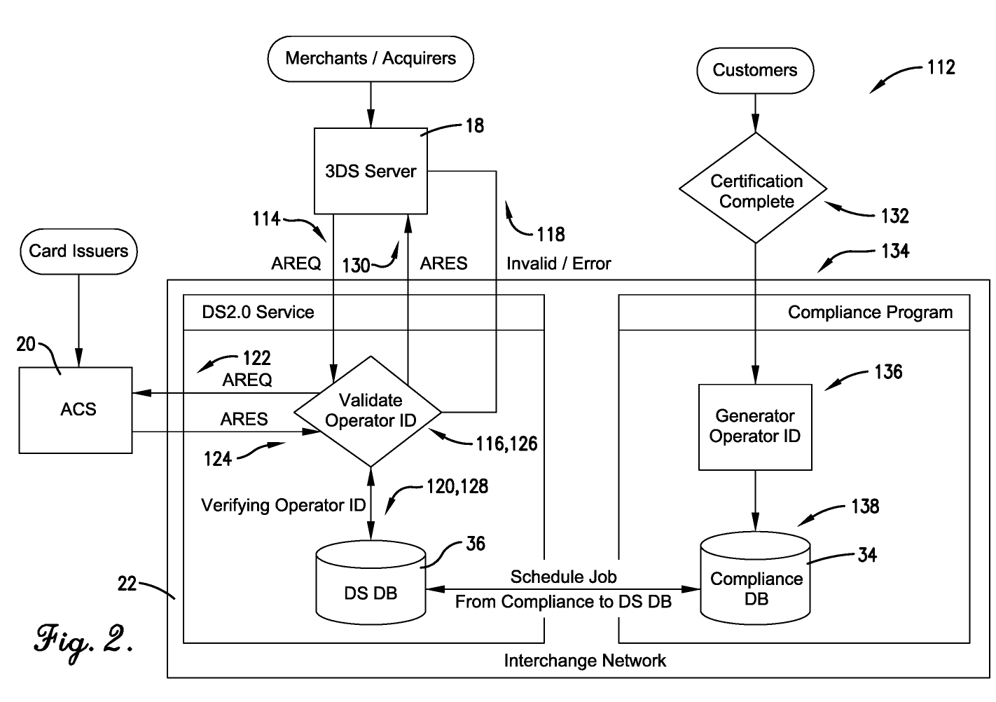

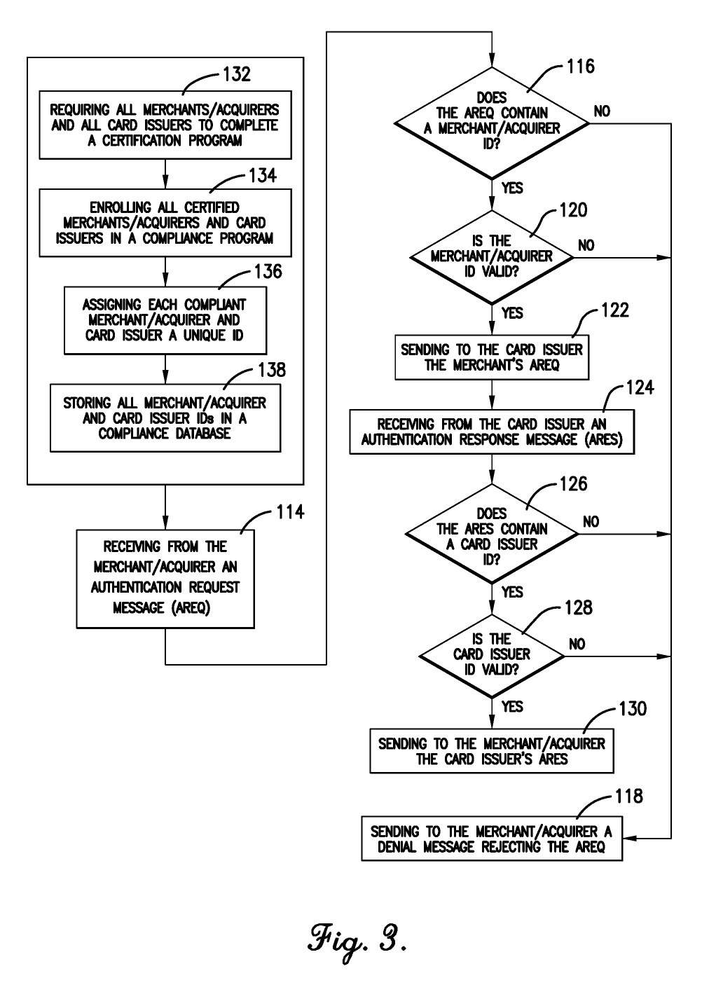

Referring also to FIGS. 2 and 3, an embodiment of the system 10 may function substantially as follows. Preliminarily, customers of the Interchange Network 22, such as the Merchant/Acquirer 18 and the Card Issuer 20, may be required to have operator IDs, as shown in 112. In one implementation, the Merchant/Acquirer may be required to have a 3DS Server Operator ID or other merchant ID, and the Card Issuer may be required to have an ACS Operator ID or other card issuer ID. One possible process for acquiring these operator IDs is discussed below in the description of the computer-implemented method.

Thereafter, the interchange network system 22 may receive an AREQ from the merchant device 18 via the communications network 12, as shown in 114. The interchange network system 22 may determine whether the AREQ contains a merchant ID, as shown in 116, and if it does not, then the interchange network system 22 may send to the merchant device 18 a denial message rejecting the AREQ, as shown in 118. The interchange network system 22 may determine whether the merchant ID contained in the AREQ is valid, as shown in 120, and if it is not, then the interchange network system 22 may send to the merchant device 18 a denial message rejecting the authentication request message, as shown in 118.

The interchange network system 22 may send the AREQ having a validated merchant/acquirer ID to the card issuer device 20 via the communications network 12, as shown in 122, and in response, may receive an ARES from the card issuer device 20 via the communications network 12, as shown in 124. The interchange network system 22 may determine whether the ARES contains a card issuer ID, as shown in 126, and if it does not, then the interchange network system 22 may send to the merchant device 18 a denial message rejecting the AREQ, as shown in 118. The interchange network system 22 may determine whether the card issuer ID contained in the ARES is valid, as shown in 128, and if it is not, then the interchange network system 22 may send to the merchant device 18 a denial message rejecting the authentication request message, as shown in 118. The interchange network system 22 may send the ARES having a validated card issuer ID to the merchant device 18 via the communications network 12, as shown in 130.

The system 10 may include more, fewer, or alternative components and/or perform more, fewer, or alternative actions, including those discussed elsewhere herein, and particularly those discussed in the following section describing the computer-implemented method.

Referring again to FIG. 3, an embodiment of a computer-implemented method 110 is shown for processing CNP transactions and protecting against fraud by requiring and validating merchant/acquirer and card issuer IDs prior to authorizing the transactions. The computer-implemented method 110 may be a corollary to the functionality of the system 10 of FIGS. 1 and 2, and may be similarly implemented using the various components of the system 10 within the above-described exemplary operating environment. Broadly, the method 110 may proceed substantially as follows.

Preliminarily, some or all customers may be required to have operator IDs, as shown in 112. In particular, Merchants/Acquirers may be required to have 3DS Server Operator IDs and Card Issuers may be required to have ACS Operator IDs. In one implementation, requiring all customers to have operator IDs may involve the following. All Merchants/Acquirers and Card Issuers may be required to complete compliance testing offered by the Interchange Network, as shown in 132. All approved Merchants/Acquirers and approved Card Issuers may be enrolled in a compliance program maintained by the Interchange Network, as shown in 134. Each enrolled and compliant Merchant/Acquirer may be assigned a unique 3DS Server Operator ID by the Interchange Network 22, and each enrolled and compliant Card Issuer may be assigned a unique ACS Operator ID by the Interchange Network 22, as shown in 136. The assigned 3DS Server Operator IDs and ACS Operator IDs may be stored in the Compliance Database 34, as shown in 138. Each such operator ID may include at least a unique numeric or alphanumeric identifier for the Merchant/Acquirer or Card Issuer, a version of the 3DS or other software specification, and a 3DS server, ACS, or similar indicator.

Thereafter, the Merchant/Acquirer may send an authentication request (AREQ) using 3DS Server software to the Interchange Network, as shown in 114. The Interchange Network 22 may determine whether the AREQ includes a 3DS Server Operator ID, as shown in 116. If the AREQ does not include a 3DS Server Operator ID, then the Interchange Network may deny the Merchant's/Acquirer's AREQ and transmit an Invalid Request or other error message to the Merchant/Acquirer, as shown in 118. If the AREQ does include a 3DS Server Operator ID, then the Interchange Network 22 may determine whether the 3DS Operator ID is valid, as shown in 120. This may be accomplished by querying the Compliance Database 34 in which the valid operator IDs are stored to find this particular 3DS Server Operator ID. If the AREQ does not include a valid 3DS Server Operator ID, then the Interchange Network may deny the Merchant's/Acquirer's AREQ and transmit an Invalid Request or other error message to the Merchant/Acquirer, as shown in 118.

If the AREQ does include a valid 3DS Server Operator ID, then the Interchange Network may send the AREQ to the appropriate Card Issuer, as shown in 122. Determining the appropriate Card Issuer to which to send the particular AREQ may involve querying the Directory Database 36. The Card Issuer receiving the AREQ may respond to the Interchange Network with an authentication response (ARES) using ACS software, as shown in 124. The Interchange Network may determine whether the ARES includes an ACS Operator ID, as shown in 126. If the ARES does not include an ACS Operator ID, then the Interchange Network may deny the Merchant's/Acquirer's AREQ and transmit an Invalid Request or other error message to the Merchant/Acquirer, as shown in 118. If the ARES does include an ACS Operator ID, then the Interchange Network may determine whether the ACS Operator ID is valid, as shown in 128. This may be accomplished by querying the Compliance Database 34 in which the valid operator IDs are stored to find this particular ACS Operator ID. If the ARES does not include a valid ACS Operator ID, then the Interchange Network may deny the Merchant's/Acquirer's AREQ and transmit an Invalid Request or other error message to the Merchant/Acquirer, as shown in 118. If the ARES does include a valid ACS Operator ID, then the Interchange Network may send the ARES to the Merchant/Acquirer, thereby completing the authentication process, as shown in 130. Following authentication, the entities may proceed to authorizing the transaction.

In one implementation, both the Merchant's/Acquirer's 3DS Server Operator ID and the Card Issuer's ACS Operator ID must be presented and validated for the authentication process to be completed. In another implementation, the Interchange Network may allow the authentication process to continue even if one or both of the Operator IDs is not presented and/or not validated. For example, a validated Card Issuer may be given the choice of authenticating a transaction initiated by an unvalidated Merchant/Acquirer. If the Card Issuer chooses to authenticate such a transaction, certain transaction protections may be withheld from the Merchant/Acquirer and/or the Card Issuer.

In one implementation, in which at least some Merchants/Acquirers operate under conditions that hinder or prevent them from completing the Compliance Test then their Vendors (of the 3DS Server software) may be allowed to complete the Compliance Test, may be assigned an operator ID, and the Merchants/Acquirer may be allowed to use their Vender's operator ID.

The computer-implemented method 110 may include more, fewer, or alternative actions, including those discussed elsewhere herein.

Any actions, functions, steps, and the like recited herein may be performed in the order shown in the figures and/or described above, or may be performed in a different order. Furthermore, some steps may be performed concurrently as opposed to sequentially. Although the computer-implemented method is described above, for the purpose of illustration, as being executed by an exemplary system and/or exemplary physical elements, it will be understood that the performance of any one or more of such actions may be differently distributed without departing from the spirit of the present invention.

A computer-readable medium comprising a non-transitory medium may include an executable computer program stored thereon and for instructing one or more processing elements to perform some or all of the steps described herein, including some or all of the steps of the computer-implemented method. The computer program stored on the computer-readable medium may instruct the processing element and/or other components of the system to perform additional, fewer, or alternative actions, including those discussed elsewhere herein.

All terms used herein are to be broadly interpreted unless otherwise stated. For example, the term “payment card” and the like may, unless otherwise stated, broadly refer to substantially any suitable transaction card, such as a credit card, a debit card, a prepaid card, a charge card, a membership card, a promotional card, a frequent flyer card, an identification card, a prepaid card, a gift card, and/or any other device that may hold payment account information, such as mobile phones, Smartphones, personal digital assistants (PDAs), key fobs, and/or computers. Each type of transaction card can be used as a method of payment for performing a transaction.

The terms “processing element,” “processor,” and the like, as used herein, may, unless otherwise stated, broadly refer to any programmable system including systems using central processing units, microprocessors, microcontrollers, reduced instruction set circuits (RISC), application specific integrated circuits (ASIC), logic circuits, and any other circuit or processor capable of executing the functions described herein. The above examples are example only, and are thus not intended to limit in any way the definition and/or meaning of the term “processing element.” In particular, “a processing element” may include one or more processing elements individually or collectively performing the described functions. In addition, the terms “software,” “computer program,” and the like, may, unless otherwise stated, broadly refer to any executable code stored in memory for execution on mobile devices, clusters, personal computers, workstations, clients, servers, and a processor or wherein the memory includes read-only memory (ROM), electronic programmable read-only memory (EPROM), random access memory (RAM), erasable electronic programmable read-only memory (EEPROM), and non-volatile RAM (NVRAM) memory. The above memory types are exemplary only, and are thus not limiting as to the types of memory usable for storage of a computer program.

The terms “computer,” “computing device,” and the like, as used herein, may, unless otherwise stated, broadly refer to substantially any suitable technology for processing information, including executing software, and may not be limited to integrated circuits referred to in the art as a computer, but may broadly refer to a microcontroller, a microcomputer, a programmable logic controller (PLC), an application specific integrated circuit, and other programmable circuits, and these terms are used interchangeably herein.

The term “communications network” and the like, as used herein, may, unless otherwise stated, broadly refer to substantially any suitable technology for facilitating communications (e.g., GSM, CDMA, TDMA, WCDMA, LTE, EDGE, OFDM, GPRS, EV-DO, UWB, WiFi, IEEE 802 including Ethernet, WiMAX, and/or others), including supporting various local area networks (LANs), personal area networks (PAN), or short range communications protocols.

The term “communications element” and the like, as used herein, may, unless otherwise stated, broadly refer to substantially any suitable technology for facilitating communications, and may include one or more transceivers (e.g., WWAN, WLAN, and/or WPAN transceivers) functioning in accordance with IEEE standards, 3GPP standards, or other standards, and configured to receive and transmit signals via a communications network.

The term “memory element,” “data storage device,” and the like, as used herein, may, unless otherwise stated, broadly refer to substantially any suitable technology for storing information, and may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others.

Although the invention has been described with reference to the one or more embodiments illustrated in the figures, it is understood that equivalents may be employed and substitutions made herein without departing from the scope of the invention as recited in the claims.

Having thus described one or more embodiments of the invention, what is claimed as new and desired to be protected by Letters Patent includes the following:

1. A system for managing an authentication process initiated by an authentication request from a merchant/acquirer to a card issuer for a card-not-present payment transaction, the system comprising:
an electronic communications element configured to facilitate communications via a communications network;
an electronic memory element configured to store a plurality of valid operator identifications;
an electronic processing element configured to
receive via the electronic communications element an authentication request message from the merchant/acquirer;
determine whether the authentication request message contains a merchant/acquirer operator identification, and terminate the authentication process and send to the merchant/acquirer a denial message via the electronic communications element rejecting the authentication request message if the authentication request message does not contain the merchant/acquirer operator identification;
determine whether the merchant/acquirer operator identification contained in the authentication request message is valid by searching for the merchant/acquirer operator identification among the plurality of valid operator identifications stored in the electronic memory element, and terminate the authentication process and send to the merchant/acquirer a denial message via the electronic communications element rejecting the authentication request message if the merchant/acquirer operator identification is not valid;
if the card issuer identification is valid, send to the card issuer the authentication request message via the electronic communications element, and receive from the card issuer an authentication response message via the electronic communications element;
determine whether the authentication response message contains a card issuer operator identification, and terminate the authentication process and send to the merchant/acquirer a denial message via the electronic communications element rejecting the authentication request message if the authentication response message does not contain the card issuer operator identification;
determine whether the card issuer operator identification contained in the authentication response message is valid by searching for the card issuer operator identification among the plurality of valid operator identifications stored in the electronic memory element, and terminate the authentication process and send to the merchant/acquirer a denial message via the electronic communications element rejecting the authentication request message if the card issuer operator identification is not valid; and
if the card issuer identification is valid, send to the merchant/acquirer the authentication response message from the card issuer via the electronic communications element if the merchant/acquirer operator identification and the card issuer operator identification are valid.

2. The system of claim 1, wherein the card-not-present payment transaction follows a 3DS protocol.

3. The system of claim 1, wherein the merchant/acquirer sends the authentication request message using 3DS server software.

4. The system of claim 1, wherein the card issuer sends the authentication response message using ACS software.

5. The system of claim 1, wherein the merchant/acquirer operator identification and the card issuer operator identification each include a unique alphanumeric identifier.

6. The system of claim 1, further including
requiring the merchant/acquirer and the card issuer to complete a compliance test;
enrolling the merchant/acquirer and the card issuer in a compliance program;
assigning the merchant/acquirer operator identification to the merchant/acquirer, and assigning the card issuer operator identification to the card issuer; and
storing the merchant/acquirer operator identification and the card issuer operator identification among the plurality of valid operator identifications in a compliance database contained in the electronic memory element,
wherein determining whether the merchant/acquirer operator identification contained in the authentication request message is valid and whether the card issuer operator identification contained in the authentication response message is valid includes querying the compliance database.

7. The system of claim 1, further including
allowing a vendor to have a vendor operator identification; and
allowing the merchant/acquirer to use the vendor operator identification as the merchant/acquirer operator identification.

8. A computer-implemented method for improving the functioning of a computer for managing an authentication process initiated by an authentication request from a merchant/acquirer to a card issuer for a card-not-present payment transaction, the computer-implemented method comprising:
receiving from the merchant/acquirer an authentication request message;
determining whether the authentication request message contains a merchant/acquirer operator identification, and terminating the authentication process and sending to the merchant/acquirer a denial message rejecting the authentication request message if the authentication request message does not contain the merchant/acquirer operator identification;
determining whether the merchant/acquirer operator identification contained in the authentication request message is valid by searching for the merchant/acquirer operator identification among a plurality of valid operator identifications, and terminating the authentication process and sending to the merchant/acquirer a denial message rejecting the authentication request message if the merchant/acquirer operator identification is not valid;
if the merchant/acquirer identification is valid, sending to the card issuer the authentication request message, and receiving from the card issuer an authentication response message;
determining whether the authentication response message contains a card issuer operator identification, and terminating the authentication process and sending to the merchant/acquirer a denial message rejecting the authentication request message if the authentication response message does not contain the card issuer operator identification;
determining whether the card issuer operator identification contained in the authentication response message is valid by searching for the card issuer operator identification among the plurality of valid operator identifications, and terminating the authentication process and sending to the merchant/acquirer a denial message rejecting the authentication request message if the card issuer operator identification is not valid; and
if the card issuer identification is valid, sending to the merchant/acquirer the authentication response message from the card issuer if the merchant/acquirer operator identification and the card issuer operator identification are valid.

9. The computer-implemented method of claim 8, wherein the card-not-present payment transaction follows a 3DS protocol.

10. The computer-implemented method of claim 8, wherein the merchant/acquirer sends the authentication request message using 3DS server software.

11. The computer-implemented method of claim 8, wherein the card issuer sends the authentication response message using ACS software.

12. The computer-implemented method of claim 8, further including
requiring the merchant/acquirer and the card issuer to complete a compliance test
enrolling the merchant/acquirer and the card issuer in a compliance program;
assigning the merchant/acquirer operator identification to the merchant/acquirer, and assigning the card issuer operator identification to the card issuer; and
storing the merchant/acquirer operator identification and the card issuer operator identification in a compliance database,
wherein determining whether the merchant/acquirer operator identification contained in the authentication request message is valid and whether the card issuer operator identification contained in the authentication response message is valid includes querying the compliance database.

13. The computer-implemented method of claim 8, wherein the merchant/acquirer operator identification and the card issuer operator identification each include a unique alphanumeric identifier.

14. The computer-implemented method of claim 8, further including
allowing a vendor to have a vendor operator identification; and
allowing the merchant/acquirer to use the vendor operator identification as the merchant/acquirer operator identification.

15. A computer-implemented method for improving the functioning of a computer for managing an authentication request from a merchant/acquirer to a card issuer for a card-not-present payment transaction, the computer-implemented method comprising:
requiring the merchant/acquirer to have a merchant/acquirer operator identification, and requiring the card issuer to have a card issuer operator identification;
receiving from the merchant/acquirer an authentication request message;
determining whether the authentication request message contains the merchant/acquirer operator identification, and terminating the authentication process and sending to the merchant/acquirer a denial message rejecting the authentication request message if the authentication request message does not contain the merchant/acquirer operator identification;
determining whether the merchant/acquirer operator identification contained in the authentication request message is valid by searching for the merchant/acquirer operator identification among a plurality of valid operator identifications, and terminating the authentication process and sending to the merchant/acquirer a denial message rejecting the authentication request message if the merchant/acquirer operator identification is not valid;
if the merchant/acquirer identification is valid, sending to the card issuer the authentication request message, and receiving from the card issuer an authentication response message;
determining whether the authentication response message contains the card issuer operator identification, and terminating the authentication process and sending to the merchant/acquirer a denial message rejecting the authentication request message if the authentication response message does not contain the card issuer operator identification;
determining whether the card issuer operator identification contained in the authentication response message is valid by searching for the card issuer operator identification among the plurality of valid operator identifications, and terminating the authentication process and sending to the merchant/acquirer a denial message rejecting the authentication request message if the card issuer operator identification is not valid; and
if the card issuer identification is valid, sending to the merchant/acquirer the authentication response message from the card issuer if the merchant/acquirer operator identification and the card issuer operator identification are valid, and proceeding to perform an authorization process for authorizing the card-not-present payment transaction.

16. The computer-implemented method of claim 15, wherein the card-not-present payment transaction follows a 3DS protocol.

17. The computer-implemented method of claim 15, wherein the merchant/acquirer sends the authentication request message using 3DS server software.

18. The computer-implemented method of claim 15, wherein the card issuer sends the authentication response message using ACS software.

19. The computer-implemented method of claim 15, wherein requiring the merchant/acquirer to have a merchant/acquirer operator identification and requiring a card issuer to have a card issuer operator identification includes
requiring the merchant/acquirer and the card issuer to complete a compliance test
enrolling the merchant/acquirer and the card issuer in a compliance program;
assigning the merchant/acquirer operator identification to the merchant/acquirer, and assigning the card issuer operator identification to the card issuer; and
and storing the merchant/acquirer operator identification and the card issuer operator identification in a compliance database,
wherein determining whether the merchant/acquirer operator identification contained in the authentication request message is valid and whether the card issuer operator identification contained in the authentication response message is valid includes querying the compliance database.

20. The computer-implemented method of claim 15, further including
allowing a vendor to have a vendor operator identification; and
allowing the merchant/acquirer to use the vendor operator identification as the merchant/acquirer operator identification.
